(19) United States
(12) Patent Application Publication
(10) Pub. No.: US 2019/0277182 A1
(43) Pub. Date: Sep. 12, 2019

(54) THERMAL MANAGEMENT SYSTEM FOR A VEHICLE PROPULSION SYSTEM

(71) Applicant: GM GLOBAL TECHNOLOGY OPERATIONS LLC, DETROIT, MI (US)

(72) Inventors: Daniel J. Shepard, Ann Arbor, MI (US); Eugene V. Gonze, PINCKNEY, MI (US); Michael J. Paratore, JR., HOWELL, MI (US)

(21) Appl. No.: 15/918,425

(22) Filed: Mar. 12, 2018

(51) Int. Cl. F01P 7/16; F01P 5/10; F16H 57/04

(52) U.S. Cl. CPC F01P 7/16; F01P 5/10; F01P 2007/146; F16H 57/0417; F16H 57/0413

(57) ABSTRACT

A thermal management system for a vehicle propulsion system includes an engine having a coolant inlet and a coolant outlet, a coolant pump having an outlet in communication with the engine coolant inlet, a coolant valve that controls coolant flow from the engine coolant outlet to a transmission heat exchanger, and a coolant valve controller that selectively actuates the coolant valve during an initial transmission warm up condition, wherein the coolant valve controller selectively closes the coolant valve after a transmission temperature exceeds a target transmission temperature.

### FIELD

The present disclosure relates to a thermal management system for a vehicle propulsion system.

### INTRODUCTION

This introduction generally presents the context of the disclosure. Work of the presently named inventors, to the extent it is described in this introduction, as well as aspects of the description that may not otherwise qualify as prior art at the time of filing, are neither expressly nor impliedly admitted as prior art against this disclosure.

Current production motor vehicles, such as the modern-day automobile, are originally equipped with a powertrain that operates to propel the vehicle and power the onboard vehicle electronics. In automotive applications, for example, the propulsion system may be generally typified by a prime mover that delivers driving power through a transmission to a final drive system (e.g., rear differential, axles, and road wheels). Automobiles have traditionally been powered by a reciprocating-piston type internal combustion engine assembly because of its ready availability and relatively inexpensive cost, light weight, and overall efficiency. Such engines may include, for example, compression-ignited (CI) diesel engines, spark-ignited (SI) gasoline engines, flex-fuel models, two, four and six-stroke architectures, and rotary engines, as some non-limiting examples. Hybrid and full-electric vehicles, on the other hand, may utilize alternative power sources, such as fuel-cell or battery powered electric motor-generators, to propel the vehicle and minimize/eliminate reliance on a combustion engine for power.

During normal operation, internal combustion engine (ICE) assemblies and large traction motors (i.e., for hybrid and full-electric powertrains) may generate a significant amount of heat. To prolong the operational life of the prime mover(s) and the various components packaged within the engine compartment, vehicles may be equipped with passive and active features for managing heat in the engine bay. Passive measures for alleviating excessive heating within the engine compartment may include, for example, thermal wrapping the exhaust runners, thermal coating of the headers and manifolds, and integrating thermally insulating packaging for heat sensitive electronics. Active means for cooling the engine compartment include radiators, coolant pumps, and fans. As another option, some vehicle may include vents that expel hot air and amplify convective cooling within the engine bay.

Active thermal management systems for vehicles may employ an onboard vehicle controller or electronic control module to regulate operation of a cooling circuit that distributes liquid coolant, generally of oil, water, and/or antifreeze, throughout the components of the vehicle. A coolant pump may propel cooling fluid through coolant passages in the engine block, the transmission case and sump, and to a radiator or other heat exchanger. A radiator may transfer heat from the vehicle to ambient air. Some thermal management systems may use a split cooling system layout that features separate circuits and water jackets for the cylinder head and engine block such that the head can be cooled independently from the block. The cylinder head, which has a lower mass than the engine block and is exposed to very high temperatures, heats up much faster than the engine block and, thus, generally needs to be cooled first. Advantageously, during warm up, a split layout allows the system to first cool the cylinder head and, after a given time interval, then cool the engine block.

Internal combustion engines combust air and fuel within cylinders to generate drive torque. Combustion of air and fuel also generates heat and exhaust gases. Exhaust gases produced by an engine flows through an exhaust system before being released to the atmosphere.

Vehicle propulsion systems that include an internal combustion engine typically include a radiator that is connected to coolant channels within the engine. Engine coolant circulates through the coolant channels and the radiator. The engine coolant absorbs heat from the engine and carries heat away from the engine. The heat removed from the engine may then be provided to another component within the vehicle, such as, for example, a radiator, a heater core, a transmission heat exchanger or the like.

### SUMMARY

In an exemplary aspect, a thermal management system for a vehicle propulsion system includes an engine having a coolant inlet and a coolant outlet, a coolant pump having an outlet in communication with the engine coolant inlet, a coolant valve that controls coolant flow from the engine coolant outlet to a transmission heat exchanger, and a coolant valve controller that selectively actuates the coolant valve during an initial transmission warm up condition, wherein the coolant valve controller selectively closes the coolant valve after a transmission temperature exceeds a target transmission temperature.

In another exemplary aspect, the coolant valve controller selectively actuates the coolant valve during a post-warm up condition to close the coolant valve before the transmission temperature reaches the target transmission temperature.

In another exemplary aspect, the transmission temperature includes a transmission fluid temperature of transmission fluid in the transmission heat exchanger.

In another exemplary aspect, during the warm up condition, a temperature of a component of the transmission does not exceed the target transmission temperature.

In another exemplary aspect, the component of the transmission includes a transmission housing.

In another exemplary aspect, the coolant valve controller selectively closes the coolant valve when the transmission temperature exceeds the target transmission temperature by a predetermined amount.

In another exemplary aspect, the target transmission temperature includes a transmission temperature above which transmission spin losses increase.

In another exemplary aspect, the warm up condition extends for a predetermined amount of time.

In another exemplary aspect, the warm up condition starts in response to a vehicle start up.

In another exemplary aspect, the system further includes a heat exchanger for rejecting heat from the thermal management system and the coolant valve controller selectively actuates a second coolant valve to stop a flow of coolant through the heat rejecting heat exchanger such that all heat from the engine is directed to the transmission heat exchanger.

Further areas of applicability of the present disclosure will become apparent from the detailed description provided below. It should be understood that the detailed description and specific examples are intended for purposes of illustration only and are not intended to limit the scope of the disclosure.

The above features and advantages, and other features and advantages, of the present invention are readily apparent from the detailed description, including the claims, and exemplary embodiments when taken in connection with the accompanying drawings.

### BRIEF DESCRIPTION OF THE DRAWINGS

The present disclosure will become more fully understood from the detailed description and the accompanying drawings, wherein:

FIG. 1 is a schematic illustration of an exemplary thermal management system for a vehicle in accordance with the present disclosure;

FIG. 2 is a graph 200 illustrating a spin loss of a transmission relating transmission temperature to torque; and

FIG. 3 is a graph 300 comparing transmission fluid temperature and transmission component temperature responses of a conventional thermal management system and method and an exemplary thermal management system and method in accordance with the present disclosure.

### DETAILED DESCRIPTION

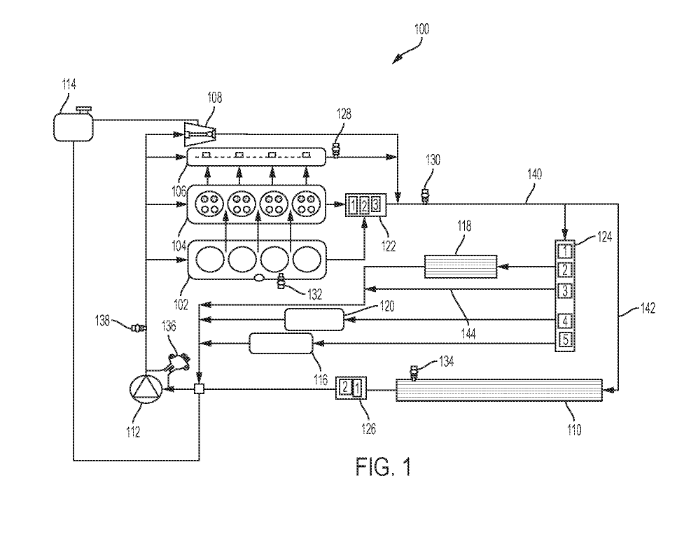

FIG. 1 illustrates an exemplary active thermal management system 100 for various components in a vehicle. The thermal management system 100 includes an engine block 102, a cylinder head 104, and an exhaust manifold 106. The exhaust manifold may be an integrated exhaust manifold in which the exhaust manifold is integrated into the cylinder head, a separate (non-integrated) exhaust manifold and/or the like without limitation which has a cooling jacket through which coolant flows. The thermal management system 100 further includes a forced-induction component 108, such as, for example, a turbocharger. In other exemplary embodiments in accordance with the present application, the forced-induction component 108 may be a supercharger, a twin-charger, a variable geometry turbine (VGT) with a VGT actuator arranged to move the vanes to alter the flow of exhaust gases through the turbine, and/or the like without limitation. Alternatively, the thermal management system might not include a forced-induction component and be naturally aspirated. The invention of the present disclosure is applicable in either configuration.

The thermal management system 100 further includes a heat exchanger (or radiator) 110, for exchanging heat between an internally flowing liquid coolant and an external fluid medium (ambient air) and/or an internal fluid medium (refrigerant). A coolant pump 112, which may be of the fixed, positive or variable displacement type, is operable for circulating liquid coolant cooled by the radiator 110 throughout the system 100. In a preferred embodiment, the pump 112 may be an electric pump which provides increased control over the volume of flow in comparison to a mechanical pump which only vary the volume of flow based upon the operated speed of the engine. In this manner, a pump having a controllable volume of flow enables significantly improved control over the amount of heat which may be transferred to, distributed between, and/or rejected from components within a vehicle. A surge tank 240 may provide a temporary storage container for retaining coolant overflow due to expansion of the coolant as it heats up, and returning coolant when cooled.

Thermal management system 100 is a split cooling system layout for independently managing heat-extracting coolant flow through the block 102, head 104, exhaust manifold 106, and turbocharger 108—and a transmission heat exchanger 116. The illustrated thermal management system 100 also independently manages coolant flow to the radiator 110, a cabin heater core 118, engine oil heat exchanger 120, and the transmission heat exchanger 116. With this configuration, the thermal management system 100 is capable of separately and independently controlling which part or parts of the engine to cool at a given time, and to which component or components of the vehicle propulsion system or passenger cabin energy will be delivered in the form of heated coolant. Coolant circulation may be governed by a controller (not shown) through controlled operation of at least the pump 112, an engine rotary valve 122, a main rotary valve 124, and radiator valve 126. The controller may control operation of the pump 112, and valves 122, 124, and 126, in response to signals received from sensors, such as, for example, manifold outlet temperature sensor 128, engine outlet temperature sensor 130, block temperature sensor 132, radiator coolant temperature sensor 134, pump pressure sensor 136, engine inlet temperature sensor 138, coolant pressure sensor 146, and/or the like without limitation. The controller may be incorporated into, be distinct from yet collaborative with, or be fabricated as a wholly independent from other controllers in the vehicle and/or vehicle propulsion system.

The thermal management system 100 employs several branches of conduits for fluidly connecting the illustrated components and splitting the coolant flow among the several loops of the system. The thermal management system 100 may include an engine outlet conduit 140 which receives all coolant flowing through the block 102, the head 104, the manifold 106, and the turbocharger 108, the proportions through each of those components being determined by the engine rotary valve 122. In a preferred, exemplary embodiment, the coolant pressure sensor 146 is positioned to sense the pressure of the coolant in the engine outlet conduit 140. In this manner, the coolant pressure sensor 146 is positioned to sense the pressure of the coolant where the coolant is most likely at the highest temperature and, thus, pressure in comparison to other potential locations in the system 100.

The thermal management system 100 may also include a radiator conduit 142 having an inlet in communication with the engine outlet conduit 140 and an outlet in communication with an inlet to the pump 112. The flow of coolant through the radiator conduit 142 is determined by the radiator valve 126. An independently controlled radiator conduit which places the radiator on its own, completely separate, and independent flow path feature is quite unique and not present in conventional vehicle thermal management systems. This obviates the necessity of providing a radiator bypass flow path which is directly tied to the flow through the radiator, as may be found in many conventional thermal management systems. In contrast, the exemplary thermal management system architecture enables complete control over the amount of energy rejected from the system overall, via the radiator, and enables independent and complete control over the distribution of heat to vehicle components which may consume (distribute heat to vehicle components other than those directly related to the engine) and/or maintain heat within the system via the use of a bypass conduit 144 which then returns the heat energy back to the engine components. In this manner, control over the heat energy present within the entire thermal management system may be directly and independently controlled. Thereby further enabling distribution of heat between components that may benefit from additional heat rather than rejecting and/or wasting that heat energy by rejecting it to the ambient environment as has been done by conventional vehicle thermal management systems.

Co-pending, co-assigned U.S. patent application Ser. No. 15/145,417, the disclosure of which is hereby incorporated herein in its entirety, discloses an inventive thermal management system having a radiator conduit which is separate from and independently controlled from other flow paths. As described above, this enables consideration of overall system heat when deciding whether and when to reject heat from the overall system. However, in contrast to the present disclosure, that disclosure describes a system and method which determines the flow through the radiator based upon the cooling requirements of the engine only, and does not consider the thermal considerations of other components within the vehicle.

The main rotary valve 124 also has an inlet in communication with the engine outlet conduit 140 and, in combination with the radiator valve 126, determines the proportion of flow through that valve 124 and into one or more heat exchangers, such as, for example, the cabin heater core 118, the engine oil heater 120, and transmission heat exchanger 116, and/or through a bypass conduit 144. In this manner, through control over the main rotary valve 124, the radiator valve 126 and the pump 112, unprecedented flexibility is achieved in how much heat may be independently transferred between components in the vehicle, rejected to the ambient environment (via the radiator 110), and/or maintained within the system (via the bypass conduit 144). In other words, the inventive thermal management system of the present application may be broadly characterized by a plurality of operating modes: 1) a bypass mode, 2) a heat rejection mode; 3) a heat transfer mode; and 4) any combination of these modes.

It is further envisioned that the number, arrangement, and individual characteristics of the fluid ports in any given valve may be varied from that which are shown in the drawings and remain within the scope of the present disclosure.

Additional description of the vehicle thermal management system 100 is found in co-pending, co-assigned U.S. patent application Ser. No. 15/883,257, the disclosure of which is hereby incorporated by reference in its entirety. In an exemplary embodiment of the system and method of the present disclosure,

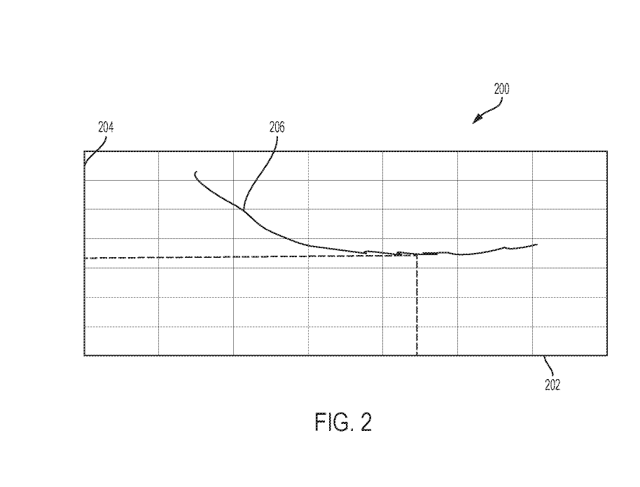

FIG. 2 is a graph 200 illustrating a spin loss of a transmission relating transmission temperature to torque. The horizontal axis 202 represents transmission temperature and the vertical axis 204 represents the amount of spin loss torque in the transmission. In general, spin loss may be understood to be a loss in efficiency in the operation of the transmission. Graph 200 represents the spin loss in terms of torque 204. A spin loss curve 206 illustrates the amount of torque associated with spin loss across a range of transmission operating temperatures. In order to maximize efficiency, it is desirable to operate the transmission at a temperature which minimizes spin loss torque. This lowest point along the curve 206 corresponds to the transmission temperature which coincides with the lowest spin loss. Conventional thermal management systems include a transmission heat exchanger which enables a degree of control over the flow of heat into the transmission. For example, co-assigned, U.S. Pat. No. 9,732,662, (“the '662 patent) the disclosure of which is hereby incorporated by reference in its entirety, discloses systems and methods for transmission temperature regulation. This disclosure explains that the viscosity of transmission fluid is inversely related to the temperature of the transmission fluid and that losses associated with the transmission may decrease as the viscosity of the transmission fluid decreases. This may be especially important when, for example, a vehicle is started in cold weather, the high viscosity of the cold transmission fluid may cause significant spin losses. Depending upon the temperature, in the absence of the systems and methods disclosed in the '662 patent, for example, it may be several minutes before the transmission fluid temperature rises into a range where spin losses are minimized. Thus, the systems and methods of the '662 patent are generally concerned with quickly increasing the temperature of the transmission fluid to quickly reduce transmission losses.

Even prior to these systems and methods, transmission oil coolers may have been provided for the purpose of minimizing the possibility that the transmission fluid temperature exceeds a temperature at which the transmission may suffer damage and/or to extend the life of the transmission.

The inventors of the present disclosure realized that the temperature of the components of the transmission such as, for example, the transmission housing, gears, and the like, also effect the temperature of the transmission and the rate at which the transmission reaches a desired operating temperature. During an initial start-up and/or warm-up condition, not only does the temperature of the transmission fluid require warming to reach a desired operating temperature, but the components of the transmission also need to be warmed up. Transmission components remove heat from the transmission fluid when the transmission fluid is warmer than the transmission components. In an initial warm-up, the colder transmission components tend to reduce the rate at which the transmission fluid reaches a desired operating temperature.

In accordance with an exemplary aspect of the present disclosure, a thermal management system for a vehicle propulsion system permits the transmission fluid temperature to exceed a predetermined threshold temperature during a warm up condition.

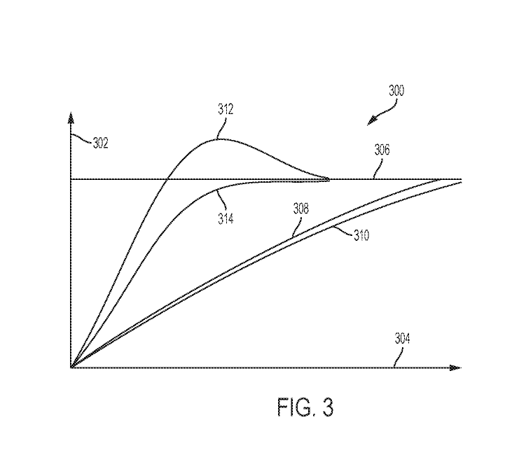

FIG. 3 is a graph 300 comparing transmission fluid temperature and transmission component temperature responses of a conventional thermal management system and method and an exemplary thermal management system and method in accordance with the present disclosure. Temperature is represented on the vertical axis 302 and the passage of time is represented on the horizontal axis 304. A target transmission temperature is represented as line 306. As explained above, it is desirable for the transmission temperature to reach the target transmission temperature 306 as quickly as possible to reduce spin losses in the transmission. In a conventional thermal management system, the transmission fluid temperature response 308 slowly increases and gradually approaches the target transmission temperature 306. These thermal management systems and methods do not permit the transmission fluid temperature 308 to exceed the target transmission temperature. The temperature of components, such as, for example, the transmission housing, gears, and the like, is represented as a transmission component temperature response 310. In general, the transmission component temperature response 310 closely follows, just below, the transmission fluid temperature response 308.

In stark contrast, in accordance with an exemplary embodiment of the present disclosure, the transmission fluid temperature response 312 is permitted to exceed the target temperature 306. In response, the transmission component temperature 314 rises much more quickly. Permitting the transmission fluid temperature to rapidly increase and to even exceed a target temperature, results in a larger gap between the transmission fluid temperature 312 and the transmission component temperature 314. An increase in the temperature gap results in an increase in the rate of heat transfer between the transmission fluid and the transmission components. This enables the transmission component temperature 314 to increase at a much higher rate than has conventionally been possible.

As the transmission component temperature 314 approaches the target temperature 306, the thermal management system and method stops sending additional heat to the transmission heat exchanger, which results in the transmission fluid temperature 312 to start to decrease. Gradually, the gap between the transmission fluid temperature 312 and the transmission component temperature 314 continues to decrease, as heat continues to transfer from the transmission fluid to the transmission components. In this manner, during a warm up condition, the transmission temperature reaches a predetermined temperature much more quickly, resulting in improved efficiency, performance, and reduced emissions.

This description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims.

What is claimed is:

1. A thermal management system for a vehicle propulsion system, the thermal management system comprising:
an engine having a coolant inlet and a coolant outlet;
a coolant pump having an outlet in communication with the engine coolant inlet;
a coolant valve that controls coolant flow from the engine coolant outlet to a transmission heat exchanger; and
a coolant valve controller that selectively actuates the coolant valve during an initial transmission warm up condition, wherein the coolant valve controller selectively closes the coolant valve after a transmission temperature exceeds a target transmission temperature.

2. The system of claim 1, wherein the coolant valve controller selectively actuates the coolant valve during a post-warm up condition to close the coolant valve before the transmission temperature reaches the target transmission temperature.

3. The system of claim 1, wherein the transmission temperature comprises a transmission fluid temperature of transmission fluid in the transmission heat exchanger.

4. The system of claim 3, wherein, during the warm up condition, a temperature of a component of the transmission does not exceed the target transmission temperature.

5. The system of claim 4, wherein the component of the transmission comprises a transmission housing.

6. The system of claim 1, wherein the coolant valve controller selectively closes the coolant valve when the transmission temperature exceeds the target transmission temperature by a predetermined amount.

7. The system of claim 1, wherein the target transmission temperature comprises a transmission temperature above which transmission spin losses increase.

8. The system of claim 1, wherein the warm up condition extends for a predetermined amount of time.

9. The system of claim 1, wherein the warm up condition starts in response to a vehicle start up.

10. The system of claim 1, further comprising a heat exchanger for rejecting heat from the thermal management system and wherein the coolant valve controller selectively actuates a second coolant valve to stop a flow of coolant through the heat rejecting heat exchanger such that all heat from the engine is directed to the transmission heat exchanger.

11. A vehicle with a thermal management system for a vehicle propulsion system, the thermal management system comprising:
an engine having a coolant inlet and a coolant outlet;
a coolant pump having an outlet in communication with the engine coolant inlet;
a coolant valve that controls coolant flow from the engine coolant outlet to a transmission heat exchanger; and
a coolant valve controller that selectively actuates the coolant valve during an initial transmission warm up condition, wherein the coolant valve controller selectively closes the coolant valve after a transmission temperature exceeds a target transmission temperature.

12. The vehicle of claim 11, wherein the coolant valve controller selectively actuates the coolant valve during a post-warm up condition to close the coolant valve before the transmission temperature reaches the target transmission temperature.

13. The vehicle of claim 11, wherein the transmission temperature comprises a transmission fluid temperature of transmission fluid in the transmission heat exchanger.

14. The vehicle of claim 13, wherein, during the warm up condition, a temperature of a component of the transmission does not exceed the target transmission temperature.

15. The vehicle of claim 14, wherein the component of the transmission comprises a transmission housing.

16. The vehicle of claim 11, wherein the coolant valve controller selectively closes the coolant valve when the transmission temperature exceeds the target transmission temperature by a predetermined amount.

17. The vehicle of claim 11, wherein the target transmission temperature comprises a transmission temperature above which transmission spin losses increase.

18. The vehicle of claim 11, wherein the warm up condition extends for a predetermined amount of time.

19. The vehicle of claim 11, wherein the warm up condition starts in response to a vehicle start up.

20. The vehicle of claim 11, further comprising a heat exchanger for rejecting heat from the thermal management system and wherein the coolant valve controller selectively actuates a second coolant valve to stop a flow of coolant through the heat rejecting heat exchanger such that all heat from the engine is directed to the transmission heat exchanger.
